(19) United States
(12) Patent Application Publication
(10) Pub. No.: US 2026/0064853 A1
(43) Pub. Date: Mar. 5, 2026

(54) CONTROL DEVICE, CONTROL METHOD, AND COMPUTER PROGRAM PRODUCT

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Koji KITAYAMA, Kita Tokyo (JP); Mikio HASHIMOTO, Bunkyo Tokyo (JP); Shinnosuke YAMAOKA, Kunitachi Tokyo (JP); Hirohisa KUSANO, Mitaka Tokyo (JP); Kosuke IMAI, Fuchu Tokyo (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 19/285,210

(22) Filed: Jul. 30, 2025

(30) Foreign Application Priority Data
Aug. 29, 2024 (JP) 2024-147621

(51) Int. Cl. G06F 21/57; G06F 12/14

(52) U.S. Cl. CPC G06F 21/577; G06F 12/1441; G06F 21/575

(57) ABSTRACT

A control device 10 includes an MCU 20 including a CPU 22, a system bus 26, storage 28, and an address translator 24 translating an address in the CPU address space of the CPU 22 to and from an address in the system bus address space of the system bus 26 according to the translation rule set in the special function register 24A. The MCU 20 starts up in the limitation-release mode in which all addresses in the CPU address space are available, and switches to the limitation mode in which only some of the addresses in the CPU address space are available when a predetermined condition is satisfied after the start-up. For the special function register 24A, the translation rule is settable and readable in the limitation release mode, and the translation rule is neither settable nor readable in the limitation mode.

### CROSS-REFERENCE TO RELATED APPLICATIONS

This application is based upon and claims the benefit of priority from Japanese Patent Application No. 2024-147621, filed on Aug. 29, 2024; the entire contents of which are incorporated herein by reference.

### FIELD

Embodiments described herein relate generally to a control device, a control method, and a computer program product.

### BACKGROUND

Address space layout randomization (ASLR) is a known measure to lessen arbitrary-code execution attacks utilizing buffer overflow vulnerability as a clue. In this measure, a virtual memory management function is applied to randomly determine the location address of application software built in advance as a position independent executable format at every start-up, so that an attacker cannot easily guess the location address of an instruction that is to be a possible clue. Generally, ASLR is achieved by a virtual memory management function that a general-purpose operating system (OS) provides by using a memory management unit (MMU). However, the MMU is large in circuit size and requires a lot of memories for use. As such, there is a difficult problem in implementing the virtual memory management function in a micro controller unit (MCU) in the same way as the general-purpose OS and applying ASLR.

For implementing the virtual memory management function in the MCU, there is a method in which an invalid address is embedded in advance in the application software at the time of building the application software, and the virtual memory management software that operates independently and in parallel with the application software translates the invalid address to a valid address as necessary.

However, the conventional technology requires a CPU having sufficient performance for operating the application software and the virtual memory management software in parallel. In addition, when the conventional technology is applied to real-time processing, the parallel operation needs to be considered in the estimation of processing time, which sometimes makes software design difficult. In other words, with the conventional technology, it is difficult to reduce the vulnerability of the MCU with a simple configuration.

### BRIEF DESCRIPTION OF THE DRAWINGS

FIG. 1 is a schematic diagram of a control device;

FIG. 2 is a sequence diagram illustrating the flow of information processing executed by an MCU; and

FIG. 3 is a flowchart illustrating the flow of information processing executed by boot firmware.

### DETAILED DESCRIPTION

An object of the present disclosure is to provide a control device, a control method, and a computer program product that are capable of reducing the vulnerability of an MCU with a simple configuration.

According to an embodiment, a control device includes a micro controller unit (MCU). The MCU includes a central processing unit (CPU), a system bus, storage, and an address translator configured to translate an address in a CPU address space of the CPU to and from an address in a system bus address space of the system bus in accordance with a translation rule that is set in a special function register. The MCU starts up in a limitation release mode in which all addresses in the CPU address space are available, and switches to a limitation mode in which only some of the addresses in the CPU address space are available when a predetermined condition is satisfied after start-up. For the special function register, the translation rule is settable and readable in the limitation release mode, and the translation rule is neither settable nor readable in the limitation mode.

Hereinafter, a control device, a control method, and a computer program product of the present embodiment will be described in detail with reference to the drawings. The present disclosure is not limited to the following embodiments.

Note that, in descriptions of the following embodiments, constituents having substantially the same function are assigned with the same reference sign, and duplicate descriptions thereof are omitted as appropriate.

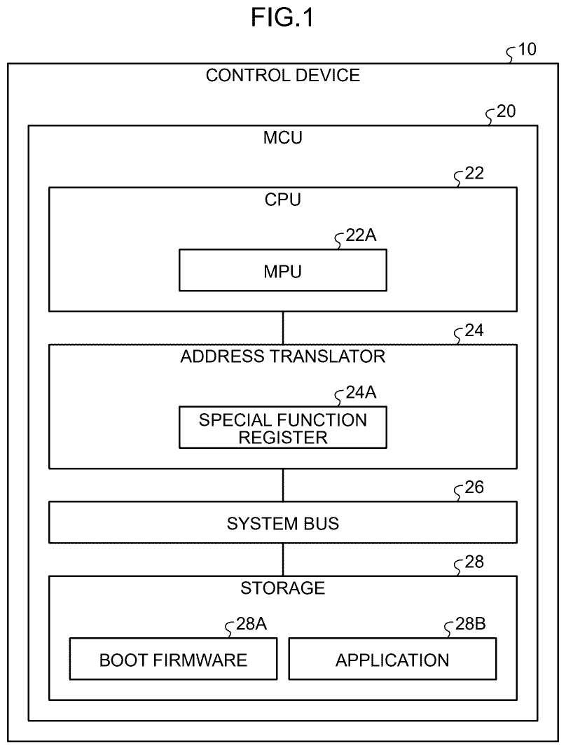

FIG. 1 is a schematic diagram illustrating an example of a control device 10.

The control device 10 includes an MCU 20. The MCU 20 includes a central processing unit (CPU) 22, an address translator 24, a system bus 26, and storage 28.

The CPU 22 is communicatively connected to the system bus 26 via the address translator 24. The system bus 26 is communicatively connected to the storage 28.

The CPU 22 includes a memory protection unit (MPU) 22A.

The address translator 24 includes a special function register 24A. The address translator 24 translates an address in a CPU address space of the CPU 22 to and from an address in a system bus address space of the system bus 26 in accordance with a translation rule set in the special function register 24A.

The CPU address space is a virtual address space of a memory area that is available to the CPU 22. The system bus address space is a physical address space of a memory area that is available to the system bus 26.

The special function register 24A is a memory element provided in the address translator 24 and configured to store the translation rule. Details of the translation rule will be described later.

The system bus 26 is a bus (a transmission path) configured to connect the CPU 22 and the address translator 24 to the storage 28 and other devices.

The storage 28 is storage provided in the MCU 20 and configured to store various types of data. Specifically, the storage 28 is storage that is not rewritable by the CPU 22. Additionally, for the storage 28, instructions are directly executable by the CPU 22.

Boot firmware 28A and one or a plurality of applications 28B are stored in advance in the storage 28.

The boot firmware 28A is a computer program for reading and writing an operating system at the start-up of the MCU 20 and for performing basic input/output control for connected devices. The boot firmware 28A is sometimes referred to as BIOS (Basic Input/Output System).

The application 28B is application software. In the present embodiment, the application software is sometimes simply referred to as an application for the sake of description. The application software is also sometimes referred to as an application program. In the present embodiment, assuming that one application 28B is stored in the storage 28, descriptions are given.

In the present embodiment, the MCU 20 starts up in limitation release mode. The MCU 20 is then switched to a limitation mode at the time when a predetermined condition is satisfied after the start-up. For example, when the predetermined condition is satisfied, one-way switching of the MCU 20 to the limitation mode is performed.

The limitation release mode is a mode in which all functional units (the CPU 22, the address translator 24, the system bus 26, and the boot firmware 28A and the application 28B included in the storage 28) included in the MCU 20 can use all addresses in the CPU address space.

The limitation mode is a mode in which all the functional units (the CPU 22, the address translator 24, the system bus 26, and the boot firmware 28A and the application 28B included in the storage 28) included in the MCU 20 can use only some of the addresses out of all of the addresses in the CPU address space.

For the special function register 24A, in the limitation release mode, the translation rule is settable and readable by each of all the functional units (the CPU 22, the address translator 24, the system bus 26, and the boot firmware 28A and the application 28B included in the storage 28) included in the MCU 20. Furthermore, for the special function register 24A, in the limitation mode, the translation rule is not settable and readable by all the functional units (the CPU 22, the address translator 24, the system bus 26, and the boot firmware 28A and the application 28B included in the storage 28) included in the MCU 20.

As such, in the MCU 20 according to the present embodiment, only in limitation release mode, the special function register 24A, in which the translation rule is set, is readable and writable. Accordingly, the MCU 20 according to the present embodiment does not need specific software configured to operate independently and in parallel with the application 28B and can achieve ASLR even when some sort of defect occurs in the application 28B due to its vulnerability. Thus, the MCU 20 according to the present embodiment can reduce the vulnerability of the MCU 20 with a simple configuration.

Hereinafter, the MCU 20 according to the present embodiment will be described in detail.

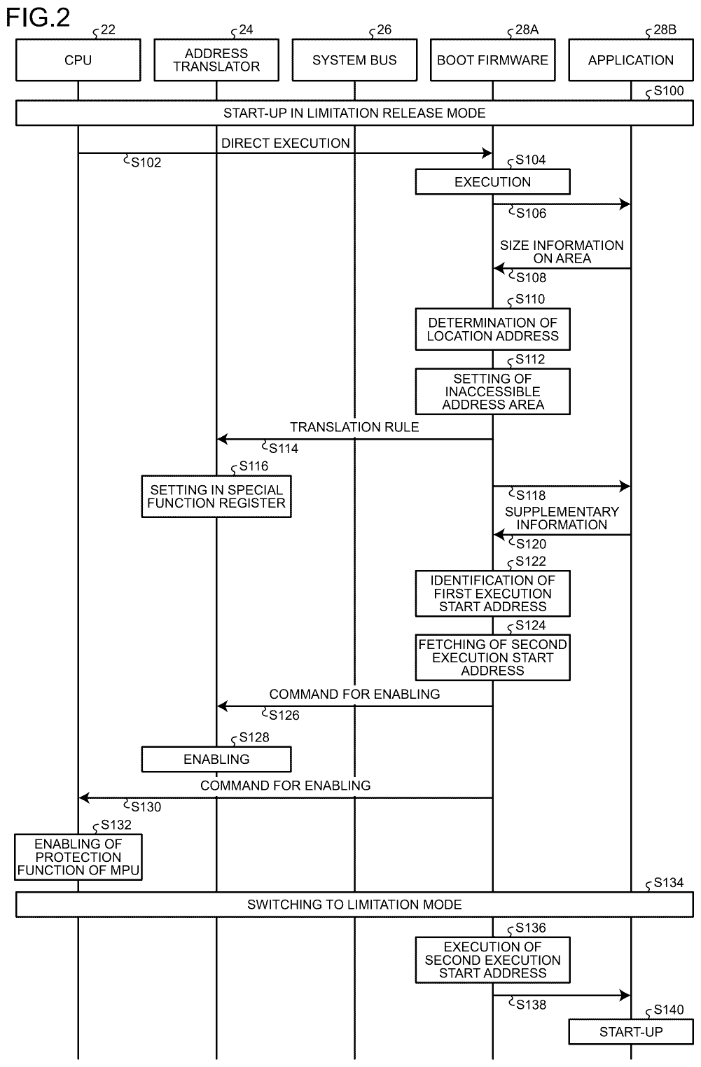

FIG. 2 is a sequence diagram illustrating an example of the flow of information processing executed by the MCU 20 according to the present embodiment.

In the present embodiment, the MCU 20 starts up in limitation release mode (Step S100).

When the MCU 20 starts up in the limitation release mode, the CPU 22 directly executes the boot firmware 28A (Step S102, Step S104). In other words, the boot firmware 28A is directly executed by the CPU 22 in the limitation release mode.

The direct execution by the MCU 20 means that the MCU 20 executes instructions without loading the instructions into RAM or other main memories.

The boot firmware 28A is executed by the CPU 22 to acquire size information indicating the sizes of a plurality of types of memory areas used by the application 28B from supplementary information of the application 28B stored in the storage 28 (Step S106, Step S108). Specific examples of the memory areas used by the application 28B include a code area, a data area, and a stack area.

Then, based on the size information acquired at Step S108, the boot firmware 28A randomly determines the location addresses, which are addresses in the CPU address spaces, of a plurality of types of the memory areas of the application 28B such that the memory areas are non-overlapped (Step S110). In other words, the boot firmware 28A randomly determines the addresses in the CPU address spaces of the memory areas such that the memory areas used by the application 28B are arranged not to be overlapped. The boot firmware 28A then uses the determined addresses as location addresses. Note that the boot firmware 28A sets the location address in an area accessible in the limitation release mode, in the CPU address space.

Next, the boot firmware 28A sets an inaccessible address area in the CPU address space when the MCU 20 is in the limitation release mode (Step S112). Note that the boot firmware 28A sets the inaccessible address area in an area that is accessible in the limitation release mode in the CPU address space and that is non-overlapping with the location addresses.

The inaccessible address area is an area that is in the CPU address space and that is other than an accessing-target area by the CPU 22. The inaccessible address area is a protected area by the MPU 22A.

Thus, when the CPU 22, the application 28B executed by the CPU 22, or another unit accesses the inaccessible address area after a protection function by the MPU 22A is enabled by processing described below, the MPU 22A emits a memory access exception signal. Note that, at Step S112, the protection function by the MPU 22A has not been enabled yet and is in a disabled state.

Next, the boot firmware 28A sets, in the special function register 24A of the address translator 24, a translation rule in which the location address that is determined at Step S110 and that is in the CPU address space of each of a plurality of types of the memory areas of the application 28B is made to correspond to the address and size in a system bus address space of each of the plurality of types of the memory areas (Step S114, Step S116). The boot firmware 28A may use the supplementary information of the application 28B acquired during processing at Step S106 and Step S108, to identify the address and size in the system bus address space of each of the plurality of types of the memory areas of the application 28B and generate the translation rule.

By setting the translation rule in the special function register 24A, the address translator 24 can translate the address in the CPU address space of each of the memory areas of the application 28B to and from the address in the system bus address space thereof in accordance with the translation rule. In other words, the address translator 24 is enabled by processing described later to enable the translation. Note that, at Step S116, the address translator 24 has not been enabled yet and is in the disabled state.

Next, the boot firmware 28A reads the supplementary information of the application 28B (Step S118, Step S120). The boot firmware 28A then identifies a first execution start address, which is an execution start address in the system bus address space of the application 28B, from the supplementary information having been read at Step S120 (Step S122).

Then, the boot firmware 28A fetches a second execution start address by using the set address randomly determined at Step S110 in the CPU address space of the memory area (Step S124). The second execution start address is an execution start address in the CPU address space, the execution start address corresponding to the first execution start address identified at Step S122 in the system bus address space. Note that the boot firmware 28A fetches the second execution start address in an area accessible in the limitation release mode in the CPU address space.

Next, the boot firmware 28A sends a command for enabling to the address translator 24 (Step S126). When receiving the command for enabling, the address translator 24 becomes enabled (Step S128). In other words, the address translator 24 becomes capable of translating the address in the CPU address space of each of the memory areas of the application 28B to and from the address in the system bus address space thereof in accordance with the translation rule set in the special function register 24A.

Next, the boot firmware 28A sends a command for enabling to enable the protection function of the MPU 22A (Step S130). Upon receipt of the command for enabling, the CPU 22 enables the protection function of the MPU 22A (Step S132). Thus, when the CPU 22, the application 28B executed by the CPU 22, or the like makes access to the inaccessible address area in the CPU address space after the protection function by the MPU 22A is enabled, the MPU 22A emits the memory access exception signal.

Next, one-way switching of the MCU 20 to the limitation mode is performed (Step S134). The one-way switching means that the limitation mode is maintained until the MCU 20 is shut down or powered off.

In other words, one-way switching of the MCU 20 from the limitation release mode to the limitation mode is performed when predetermined conditions are satisfied, that is, the translation rule is set in the special function register 24A, the address translator 24 is enabled, and the protection function of the MPU 22A is enabled.

Note that, before switching to the limitation mode, the MCU 20 may perform at least one of: processing to enable the address translator 24 to make address translatable (Step S128); and processing to enable the protection function by the MPU 22A for the inaccessible address area (Step S132). The expression “before switching to the limitation mode” connotes both during and before switching to the limitation mode.

In FIG. 2, an exemplary aspect is illustrated in which, after the processing to enable the address translator 24 (Step S128), the processing to enable the protection function by the MPU 22A (Step S132) is executed. However, the processing to enable the address translator 24 may be executed after or simultaneously with the processing to enable the protection function by the MPU 22A.

When the MCU 20 is switched to the limitation mode, the boot firmware 28A executes the second execution start address fetched at Step S124 in the CPU address space of the application 28B (Step S136). The processing at Step S136 causes the application 28B to start up (Step S138, Step S140), whereby processing is executed by the application 28B. The sequence is then terminated.

The boot firmware 28A may start up the application 28B by executing the second execution start address after one-way switching to the limitation mode. The expression “after the switching to the limitation mode” includes both during and after the switching to the limitation mode.

Note that, in FIG. 2, a description is given, assuming that one application 28B is stored in the storage 28. However, as described above, a plurality of the applications 28B may be stored in the storage 28. When the applications 28B are stored in the storage 28, the MCU 20 may perform the processing of Step S106 through Step S124 for each of the applications 28B and then perform the processing of Step S126 and subsequent steps.

Next, the flow of information processing executed by the boot firmware 28A according to the present embodiment will be described.

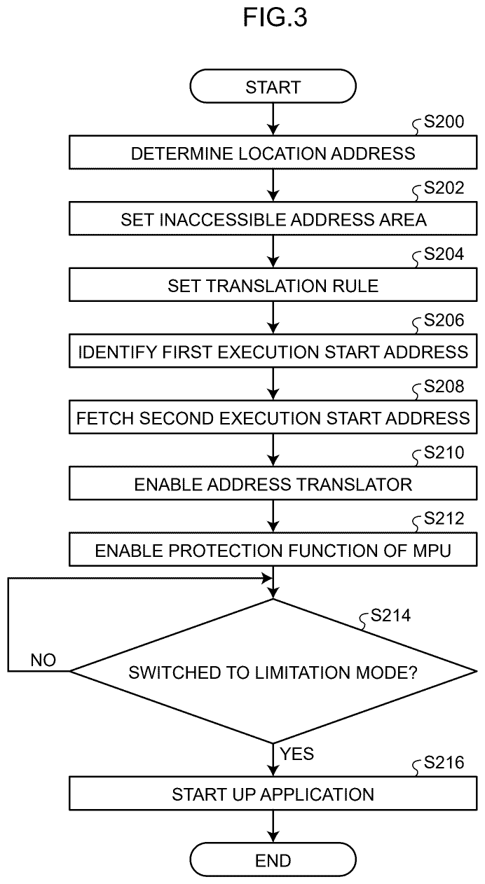

FIG. 3 is a flowchart illustrating an example of the flow of information processing executed by the boot firmware 28A.

When the MCU 20 starts up in the limitation release mode, the boot firmware 28A is executed directly by the CPU 22 to determine the location address of the boot firmware 28A stored in the storage 28 (Step S200). The boot firmware 28A acquires size information indicating the sizes of the memory areas used by the application 28B from the supplementary information of the application 28B stored in the storage 28. Based on the acquired size information, the boot firmware 28A randomly determines location addresses, which are addresses in the CPU address spaces of the memory areas of the application 28B, so that the memory areas do not overlap each other.

Next, the boot firmware 28A sets the inaccessible address area in the CPU address space (Step S202). Through the processing at Step S202, a protected area by the MPU 22A is set.

Next, the boot firmware 28A sets, in the special function register 24A of the address translator 24, a translation rule in which the location address that is determined at Step S200 and that is in the CPU address space of each of a plurality of types of the memory areas of the application 28B is made to correspond to the address and size in a system bus address space of each of the plurality of types of the memory areas (Step S204).

Next, the boot firmware 28A identifies a first execution start address in the system bus address space of the application 28B from the supplementary information of the application 28B (Step S206). By using the set address determined randomly at Step S200, the boot firmware 28A then fetches a second execution start address corresponding to the first execution start address identified at Step S206 (Step S208).

Next, the boot firmware 28A executes processing to enable the address translator 24 (Step S210). Through the processing at Step S210, the address translator 24 is enabled.

Next, the boot firmware 28A executes processing to enable the protection function of the MPU 22A (Step S212).

The boot firmware 28A then determines whether or not the MCU 20 has been switched from the limitation release mode to the limitation mode (Step S214). The boot firmware 28A repeats a negative determination (No at Step S214) until an affirmative determination (Yes at Step S214) is made at Step S214. When the boot firmware 28A makes an affirmative determination at Step S214 (Yes at Step S214), the process proceeds to Step S216.

At Step S216, the boot firmware 28A executes the second execution start address fetched at Step S208 in the CPU address space of the application 28B (Step S216). Through the processing at step S216, the application 28B starts up, whereby the processing is executed by the application 28B. After the processing at Step S216, the boot firmware 28A does not operate, whereas only the application 28B operates. The MCU 20 is switched to the limitation mode, whereby reading and writing from the CPU 22 with respect to the special function register 24A becomes in an inhibited state. The present routine is then terminated.

As described above, the control device 10 according to the present embodiment includes the MCU 20. The MCU 20 includes the CPU 22, the system bus 26, the storage 28, and the address translator 24 configured to translate an address in the CPU address space of the CPU 22 to and from an address in the system bus address space of the system bus 26 in accordance with the translation rule set in the special function register 24A. The MCU 20 starts up in the limitation release mode in which all addresses in the CPU address space are available, and, switches to the limitation mode in which only some of the addresses in the CPU address space are available, when a predetermined condition is satisfied after the start-up. For the special function register 24A, the translation rule is settable and readable in the limitation release mode, whereas the translation rule is neither settable nor readable in the limitation mode.

In this way, in the MCU 20 according to the present embodiment, the address translator 24 translates the address in the CPU address space to and from the address in the system bus address space. For the special function register 24A provided in the address translator 24 and having the function of protecting the inaccessible address area that is other than the accessing-target area by the CPU 22 in the CPU address space, the translation rule is settable and readable in the limitation release mode. In addition, for the special function register 24A, the translation rule is neither settable nor readable in the limitation mode.

Therefore, for example, even when the application 28B has vulnerability such as buffer overflow, the MCU 20 according to the present embodiment can make it difficult to execute an arbitrary code originating from the vulnerability.

In addition, the MCU 20 according to the present embodiment does not need specific software that operates independently and in parallel with the application 28B, and ASLR can be achieved in which reading a randomly determined location address in the CPU address space is prevented even when some sort of defect occurs in the application 28B due to the vulnerability.

Therefore, the MCU 20 according to the present embodiment does not need to operate specific software such as virtual memory management software in parallel with the application 28B for real-time processing or other purposes. In addition, the MCU 20 according to the present embodiment does not need a CPU exhibiting sufficient performance for such parallel operation.

Therefore, the MCU 20 according to the present embodiment can reduce the vulnerability of the MCU 20 with a simple configuration.

Thus, the control device 10 including the MCU 20 according to the present embodiment can reduce the vulnerability of the MCU 20 with a simple configuration.

Here, as a technology of applying ASLR without software configured to operate independently and in parallel with application software, there can be mentioned as a method of using a segment register included in the CPU. In other words, the technology of achieving ASLR is to specify a randomly determined address in the segment register when the application software starts up. However, when the technology is used for directly-executable storage included in a general MCU, the address specified in the segment register is limited to an address in which an application software storage area is accommodated within a segment range. In other words, there is a problem that the randomly determined address is limited to only a single segment range and ASLR therefore has a limited effect of preventing an attacker from easily guessing the location address of an instruction as a clue. In addition, application software can generally read and write a segment register, which is a register of a CPU, and therefore, when an attacker reads a randomly determined address value from the segment register by exploiting some sort of defect, the location address of an instruction can be guessed.

In contrast, in the control device 10 including the MCU 20 according to the present embodiment, the address translator 24 translates the address in the CPU address space to and from the address in the system bus address space. For the special function register 24A provided in the address translator 24 and having the function of protecting the inaccessible address area that is other than the accessing-target area by the CPU 22 in the CPU address space, the translation rule is settable and readable in the limitation release mode. In addition, for the special function register 24A, the translation rule is neither settable nor readable in the limitation mode.

Therefore, the control device 10 including the MCU 20 according to the present embodiment can achieve ASLR in which, even when some sort of defect occurs in the application 28B due to vulnerability, reading a randomly determined location address in the CPU address space is prevented.

In addition, as described above, the MCU 20 according to the present embodiment does not need to operate specific software, such as virtual memory management software, in parallel with the application 28B for real-time processing or other purposes. Therefore, in addition to the above-described effect, the control device 10 including the MCU 20 according to the present embodiment can reduce the cost of the MCU 20. Furthermore, in addition to the above-described effects, the control device 10 including the MCU 20 according to the present embodiment can also reduce software design difficulties caused by consideration of the parallel operation.

The MCU 20 according to the present embodiment includes the boot firmware 28A. After the switching to the limitation mode, the boot firmware 28A starts up the application 28B stored in the storage 28.

Thus, in the MCU 20 according to the present embodiment, the application 28B starts up after the switching to the limitation mode, and therefore, even when some sort of defect occurs due to an attack and other causes during the execution of the application 28B, the translation rule of the special function register 24A is neither settable nor readable in the limitation mode. Therefore, in addition to the above-described effects, the control device 10 including the MCU 20 according to the present embodiment can prevent a location address from being read due to attacks and the likes and thereby reduce vulnerability.

In the present embodiment, the boot firmware 28A is directly executed by the CPU 22 in the limitation release mode. The boot firmware 28A randomly determines the location address, which is an address in the CPU address space of each of the memory areas used by the application 28B, so that the memory areas do not overlap each other. The boot firmware 28A then sets, in the special function register 24A, the translation rule in which the location address in the CPU address space is made to correspond to the address in the system bus address space.

Thus, in addition to the above-described effects, the control device 10 including the MCU 20 according to the present embodiment can more effectively perform ASLR by the MCU 20.

In the control device 10 according to the present embodiment, the boot firmware 28A fetches the second execution start address in the CPU address space of the application 28B, the second execution start address corresponding to the first execution start address in the system bus address space, and after switching in the one-way manner to the limitation mode, the second execution start address is executed to start up the application 28B.

Thus, in addition to the above-described effects, the control device 10 according to the present embodiment can substantially prevent the location addresses from being read due to a defect or the like in the application 28B due to an attack or the like and thereby reduce vulnerability.

The storage 28 is storage that is not rewritable by the CPU 22 and that enables direct execution of instructions by the CPU 22.

In other words, the storage 28 is storage provided in the MCU 20. Thus, in the control device 10 according to the present embodiment, the MCU 20 according to the present embodiment is applied to the MCU including the storage 28, so that the vulnerability of an MCU 20 to attacks can be reduced.

The boot firmware 28A of the control device 10 according to the present embodiment sets the inaccessible address area that is other than an accessing-target area by the CPU 22 in the CPU address space in the limitation release mode.

As such, when the CPU 22, the application 28B, or the like makes access to the inaccessible address area after the switching to the limitation mode, the MPU 22A can detect the access as the occurrence of an error such as an attack.

Before the switching to the limitation mode, the MCU 20 of the control device 10 according to the present embodiment performs at least one of: processing to enable the address translator 24 for address translation; and processing to enable the protection function by the MPU 22A for the inaccessible address area.

Thus, after the switching from the limitation release mode to the limitation mode, ASLR can be achieved in which, even when some sort of defect occurs in the application 28B, reading the randomly determined location address is prevented.

Next, an example of the hardware configuration of the control device 10 according to the embodiment above will be described.

The control device 10 according to the embodiment above includes: a control device such as the CPU 22 including the MPU 22A; the storage 28; and a bus connecting various constituents, and has a hardware configuration making use of a common computer.

A program for executing the above-described processing performed by the control device 10 according to the embodiment above may be stored in the storage 28.

Alternatively, the program for executing the above-described processing performed by the control device 10 according to the embodiment above may be provided as a computer program product stored in a computer-readable storage medium, such as CD-ROM, CD-R, a memory card, a digital versatile disc (DVD), or a flexible disc (FD), in an installable or executable file format. Alternatively, the program for executing the above-described processing performed by the control device 10 according to the embodiment above may be stored on a computer connected to a network, such as the Internet, and downloaded via the network and provided. Alternatively, the program for executing the above-described processing performed by the control device 10 according to the embodiment above may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control device, comprising:
a micro controller unit (MCU), wherein
the MCU comprises a central processing unit (CPU), a system bus, storage, and an address translator configured to translate an address in a CPU address space of the CPU to and from an address in a system bus address space of the system bus in accordance with a translation rule set in a special function register;
the MCU
starts up in a limitation release mode in which all addresses in the CPU address space are available, and switches to a limitation mode in which only some of the addresses in the CPU address space are available when a predetermined condition is satisfied after start-up; and
for the special function register,
the translation rule is settable and readable in the limitation release mode, and
the translation rule is neither settable nor readable in the limitation mode.

2. The control device according to claim 1, wherein
the MCU includes boot firmware, and
the boot firmware starts up an application program stored in the storage after switching to the limitation mode.

3. The control device according to claim 2, wherein
the boot firmware
is executed directly by the CPU in the limitation release mode,
randomly determines a location address that is an address in the CPU address space of each of a plurality of types of memory areas used by the application program such that the memory areas are non-overlapped, and
sets, in the special function register, the translation rule in which the location address in the CPU address space is made to correspond to the address in the system bus address space.

4. The control device according to claim 2, wherein
the boot firmware
fetches a second execution start address in the CPU address space of the application program, the second execution start address corresponding to the first execution start address in the system bus address space, and
after one-way switching to the limitation mode, executes the second execution start address to start up the application program.

5. The control device according to claim 1, wherein
the storage is not rewritable by the CPU; and
for the storage, instructions are directly executable by the CPU.

6. The control device according to claim 2, wherein
in the limitation release mode, the boot firmware sets an inaccessible address area in the CPU address space, the inaccessible address area being other than an accessing-target area by the CPU.

7. The control device according to claim 6, wherein
before switching to the limitation mode, the MCU performs at least one of:
processing to enable the address translator to perform address translation; and
processing to enable a protection function by an MPU provided in the CPU for the inaccessible address area.

8. A control method implemented by a control device including a micro controller unit (MCU), the control method comprising:
by the MCU including a central processing unit (CPU), a system bus, storage, and an address translator configured to translate an address in a CPU address space of the CPU to and from an address in a system bus address space of the system bus in accordance with a translation rule set in a special function register,
starting up in a limitation release mode in which all addresses in the CPU address space are available; and
switching to a limitation mode in which only some of the addresses in the CPU address space are available, when a predetermined condition is satisfied after start-up, wherein
for the special function register,
the translation rule is settable and readable in the limitation release mode, and
the translation rule is neither settable nor readable in the limitation mode.

9. A computer program product having a non-transitory computer readable medium including instructions stored thereon, wherein the instructions cause a micro controller unit (MCU) including a central processing unit (CPU), a system bus, storage, and an address translator configured to translate an address in a CPU address space of the CPU to and from an address in a system bus address space of the system bus in accordance with a translation rule set in a special function register, to execute:
starting up in a limitation release mode in which all addresses in the CPU address space are available; and
switching to a limitation mode in which only some of the addresses in the CPU address space are available, when a predetermined condition is satisfied after start-up, wherein
for the special function register,
the translation rule is settable and readable in the limitation release mode, and
the translation rule is neither settable nor readable in the limitation mode.
